(19) United States
(12) Patent Application Publication
(10) Pub. No.: US 2013/0300322 A1
(43) Pub. Date: Nov. 14, 2013

(54) EMBEDDED INDUSTRIAL CONTROLLER WITH BICYCLE FRAME SHAPE

(71) Applicants: Yung-Sheng Tseng, Hsinchu (TW); Ching-Wei Shih, Hsinchu (TW); Shyr-Long Jeng, Hsinchu (TW); Edward-Yi Chang, Hsinchu (TW); Chia-Hua Chang, Hsinchu (TW); Bing-Shiang Yang, Hsinchu (TW); Stone Cheng, Hsinchu (TW); Wei-Hua Chieng, Hsinchu (TW); Tsung-Lin Chen, Hsinchu (TW)

(72) Inventors: Yung-Sheng Tseng, Hsinchu (TW); Ching-Wei Shih, Hsinchu (TW); Shyr-Long Jeng, Hsinchu (TW); Edward-Yi Chang, Hsinchu (TW); Chia-Hua Chang, Hsinchu (TW); Bing-Shiang Yang, Hsinchu (TW); Stone Cheng, Hsinchu (TW); Wei-Hua Chieng, Hsinchu (TW); Tsung-Lin Chen, Hsinchu (TW)

(73) Assignee: NATIONAL CHIAO TUNG UNIVERSITY, Hsinchu (TW)

(21) Appl. No.: 13/614,491

(22) Filed: Sep. 13, 2012

(30) Foreign Application Priority Data
May 8, 2012 (TW) 101116319

(51) Int. Cl. H02B 1/26; H02P 7/00

(52) U.S. Cl. 318/139; 361/622

(57) ABSTRACT

An embedded industrial controller with a bicycle frame shape is disclosed. The embedded industrial controller includes a casing with the bicycle frame shape having an upper tube, a lower tube, a front fork, a rear lower fork, a rear upper fork and a base tube, a motherboard, a battery module, a power electrical port and a plurality of input and output electrical ports. The embedded industrial controller with a bicycle frame shape of the present invention has significantly improved functions than the conventional industrial controller, and further meets the conventional requirements such as dust proof, vibration proof, and heat dissipation.

### BACKGROUND OF THE INVENTION

1. Field of the Invention The present invention relates to embedded industrial controllers, and, more particularly, to an embedded industrial controller with a bicycle frame shape.

2. Description of Related Art

An industrial controller is also called a programmable logic controller (PLC). The industrial controllers are developed in 1960s, and thus electronic devices are formed into an automation system. Therefore, industrial controllers play an important role in the industrial control field.

The current industrial controllers are PC-based, have an open structure for various interface applications, and can be used in various fields such as communication, industrial automation, medical care, environmental protection, etc., since updated soft and hard resources are used for reducing cost of research and development and increasing information processing speed.

However, the conventional industrial controllers emphasize the protection of interior components, heat dissipation and pretty appearance other than the functions of the casing.

Hence, there is an urgent need to improve a casing of an industrial controller and to increase functions of an industrial controller.

### SUMMARY OF THE INVENTION

The present invention provides an embedded industrial controller with a bicycle frame shape. The embedded industrial controller includes a casing with the bicycle frame shape including an upper tube, a lower tube, a front fork, a rear lower fork, a rear upper fork and a base tube; a motherboard disposed in the upper tube; a battery module mounted on the base tube; an electrical power port disposed on the casing and electrically connected to the motherboard and the battery module; and a plurality of input and output electrical ports disposed on the casing for receiving a first signal transmitted to the motherboard and outputting a second signal from the motherboard.

In accordance with the present invention, the motherboard includes an input unit, a control unit, a memory unit, a calculation and logic unit and an output unit.

In an embodiment of the present invention, the embedded industrial controller further includes a hub motor disposed at an intersection of the rear upper fork and the rear lower fork; and a motor driver disposed in the casing, electrically connected to the motherboard and the battery module, and transmitting a control signal to the hub motor via the plurality of input and output electrical ports.

In the embedded industrial controller of the present invention, the hub motor is driven by 24 V, 36 V or 48 V, and the hub motor is controlled by the motor driver using pulse width modulation.

In accordance with the present invention, the embedded industrial controller further includes a sensor disposed on the hub motor and electrically connected to the motherboard for measuring a rotation speed of the hub motor and transmitting the rotation speed as a feedback signal to the motherboard, wherein the sensor may be a Hall sensor, an encoder, a range finding switch, a magnetic reed switch or a combination thereof.

In comparison with the prior art, the present invention provides an embedded industrial controller with a bicycle frame shape having an improved design of a casing to be coupled with a rim, a tire, a seat pad, a handle, a pedal or a gear transmission device of a bicycle, so as to form a bicycle or an automatic bicycle with a logic control, a sequence control and a simulation control. Hence, the present invention provides a user of a bicycle using the embedded industrial controller with a bicycle frame shape with physical monitor, speed control and entertainment, and further reduces cost of an automatic bicycle.

### BRIEF DESCRIPTION OF THE DRAWINGS

FIG. 1 is a schematic view showing an embedded industrial controller with a bicycle frame shape according to a first embodiment of the present invention;

FIG. 2 is a schematic view showing an embedded industrial controller with a bicycle frame shape according to a second embodiment of the present invention;

FIG. 3 is a schematic view showing an embedded industrial controller with a bicycle frame shape according to a third embodiment of the present invention; and

FIG. 4 is a schematic view showing a bicycle using an embedded industrial controller with a bicycle frame shape according to the present invention.

### DETAILED DESCRIPTION OF THE PREFERRED EMBODIMENTS

The detailed description of the present invention is illustrated by the following specific examples. Persons skilled in the art can conceive the other advantages and effects of the present invention based on the disclosure contained in the specification of the present invention.

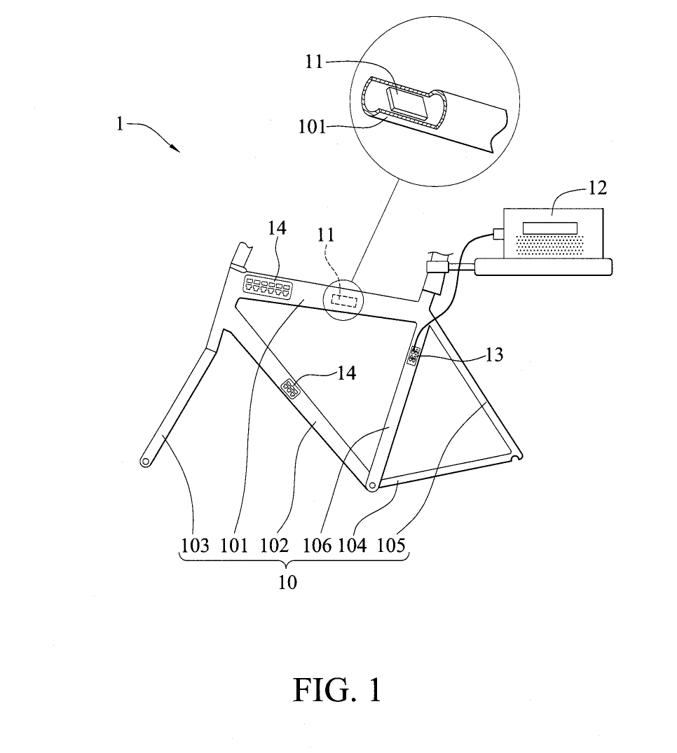

FIG. 1 is a schematic view showing an embedded industrial controller 1 with a bicycle frame shape according to a first embodiment of the present invention. As shown in FIG. 1, an embedded industrial controller with a bicycle frame shape of the present invention includes a casing 10, a motherboard 11, a battery module 12, an electrical power port 13 and a plurality of input and output electrical ports 14.

The casing 10 has a bicycle frame shape, and includes an upper tube 101, a lower tube 102, a front fork 103, a rear lower fork 104, a rear upper fork 105 and a base tube 106.

In a preferred embodiment of the present invention, the casing 10 can be made of an alloy steel, an aluminum alloy, a carbon fiber, a titanium alloy, a high carbon steel, or a combination thereof.

The motherboard 11 is disposed in the upper tube 101 and includes an input unit, a control unit, a calculation and logic unit and an output unit (not shown). The calculation and logic unit can be a chip set having an ARM structure, a chip set having an x86 structure or a single chip. In another embodiment of the present invention, the motherboard 11 can be optionally disposed on the lower tube 102, the front fork 104, the rear upper fork 105 or the base tube 106.

The battery module 12 is disposed behind the base tube 106. In a preferred embodiment of the present invention, the battery module 12 is a lead acid battery, a lithium manganese dioxide battery, a lithium battery, a lithium iron battery, a nickel hydrogen battery, a fuel battery or a combination thereof. In another embodiment of the present invention, the battery module 12 can be optionally disposed on the upper tube 102, the lower tube 102, the front fork 103, the rear lower fork 104 or the rear upper fork 105.

The electrical power port 13 is disposed on the casing 10 and electrically connected to the motherboard 11 and the battery module 12.

In another preferred embodiment of the present invention, the electrical power port 13 is an automotive connector, a cable connector, an air connector, a MIL-C-5015 circular military connector, a power connector, or a combination thereof.

The plurality of input and output electrical ports 14 are disposed on the casing 10 for receiving signals transmitted to the motherboard 11 and outputting signals from the mother board 11.

In a preferred embodiment of the present invention, the plurality of input and output electrical ports 14 RS-232/422/485 connectors, USB connectors, mini USB connectors, micro USB connectors, automotive connectors, D-type connectors, PCB connectors, European type connectors, RJ-45 connectors, HRS connectors, cable connectors, IEEE1394 connectors, HDMI connectors, mini HDMI connectors, Fujitsu connectors, Molex connectors, Weidmuller connectors, HONDA connectors, ERNI connectors, Tyco-Amp connectors, DVI connectors, FPC/FFC connectors, air connectors, SCSI connectors, MIL-C-5015 circular military connectors, mini-DIN connectors, C-type connectors, IDC connectors, DIN 41612 connectors, e-STAT connectors, STAT connectors, IDE connectors, PS/2 connectors, optical fiber S/PDIF output connectors, Modbus connectors, or a combination thereof.

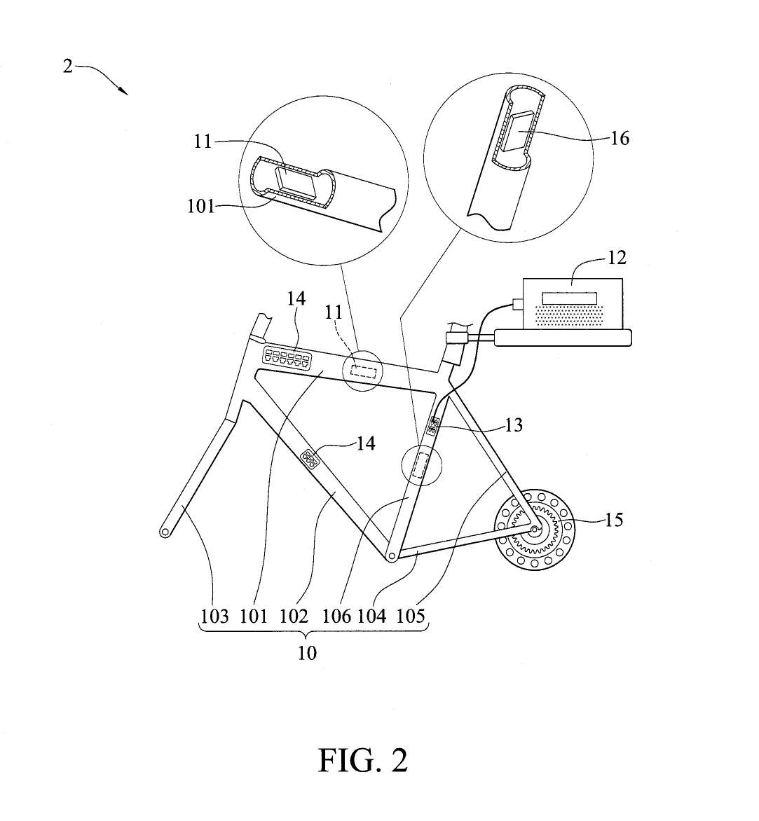

FIG. 2 is a schematic view showing an embedded industrial controller with a bicycle frame shape according to a second embodiment of the present invention. As shown in FIG. 2, an embedded industrial controller 2 with a bicycle frame shape of the present invention includes a casing 10, a motherboard 11, a battery module 12, an electrical power port 13 and a plurality of input and output electrical ports 14, a hub motor 15 and a motor driver 16.

In the second embodiment, the casing 10, the motherboard 11, the battery module 12, the electrical power port 13 and the input and output ports 14 are similar to those in the first embodiment, and thus the associated descriptions are omitted.

The hub motor 15 is disposed at the intersection of the rear lower fork 104 and the rear upper fork 105. The bicycle frame of the embedded industrial controller can be coupled with the hub motor 15 to form a bicycle such that the bicycle can be driven by the hub motor 15.

In a preferred embodiment of the present invention, the hub motor 15 can be driven by 24 V, 36 V or 48 V, and can be disposed at the end of the front fork 103.

The motor driver 16 is disposed in the casing 10 and electrically connected to the motherboard 11 and the battery module 12 for transmitting signals to the hub motor 15 via the input and output electrical ports 14.

In a preferred embodiment of the present invention, the hub motor 15 is controlled by the motor driver 16 using pulse width modulation.

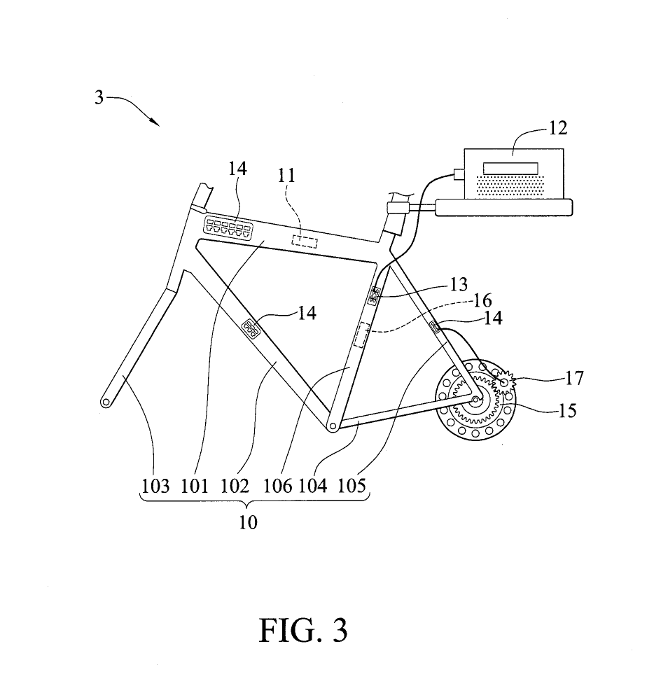

FIG. 3 is a schematic view showing an embedded industrial controller with a bicycle frame shape according to a third embodiment of the present invention. As shown in FIG. 3, an embedded industrial controller 3 with a bicycle frame shape of the present invention includes a casing 10, a motherboard 11, a battery module 12, an electrical power port 13 and a plurality of input and output electrical ports 14, a hub motor 15, a motor driver 16 and a sensor 17.

In the third embodiment, the casing 10, the motherboard 11, the battery module 12, the electrical port 13, and the input and output ports 14, the hub motor 15 and the motor driver 16 are similar to those in the second embodiment of the present invention, and thus the associated descriptions are omitted.

The sensor 17 is disposed on the hub motor 15 and electrically connected to the motherboard 11 for measuring the rotation speed of the hub motor 15 and transmitting the rotation speed as a feedback signal to the motherboard 11.

In a preferred embodiment of the present invention, the sensor 17 may be a Hall sensor, an encoder, a range finding switch, a magnetic reed switch, or a combination thereof.

In another embedment of the present invention, the sensor 17 may be optionally disposed on the upper tube 101, the lower tube 102, the front fork 103, the rear lower fork 104, the rear upper fork 105 or the base tube 106.

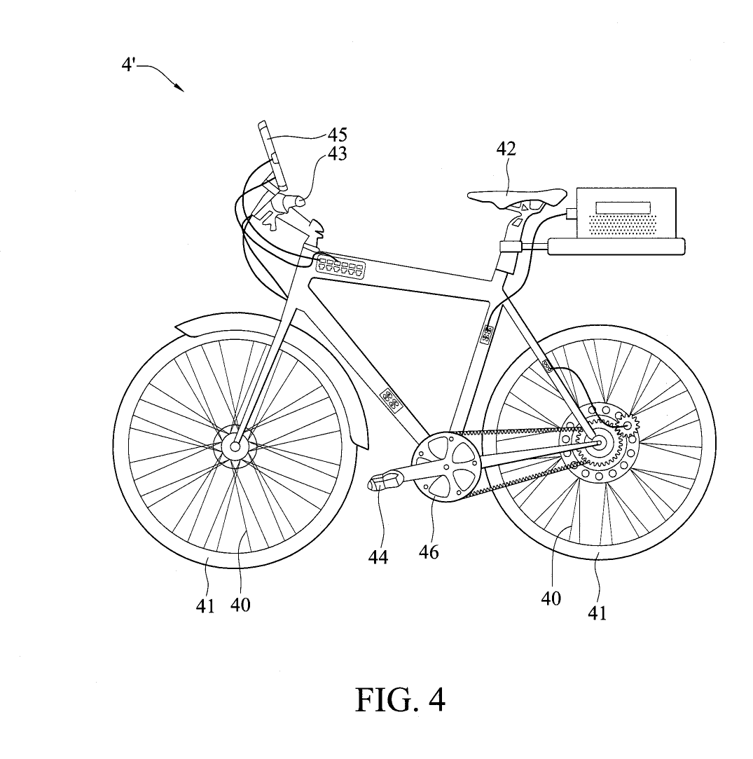

FIG. 4 is a schematic view showing a bicycle using an embedded industrial controller with a bicycle frame shape according to the present invention. As shown in FIG. 4, the embedded industrial controller with a bicycle frame shape of the present invention is coupled with a rim 40, a tire 41, a seat pad 42, a handle 43, 1 pedal 44, a touch panel 45 and a gear transmission device 46 so as to form an automatic bicycle 4′ with control functions.

In a preferred embodiment of the present invention, electrical power is transmitted by the battery module 12 via the electrical port 13 to the motherboard 11, the hub motor 15, the motor driver 16, the sensor 17 and the handle 43, wherein the handle 43 is an acceleration handle with a linear Hall signals. The user transmits signals to the motherboard 11 via the acceleration handle, then the motor driver 16 is controlled by the motherboard 11 to drive the hub motor 15, the rotation number or angle of the hub motor 15 and the pedal 44 is calculated by the sensor 17, and then the feedback signal is transmitted to the motor driver 16. Therefore, the automatic bicycle 4′ is controlled by the user at a constant speed via an interface of a touch panel 45 of the motherboard 11 electrically connected to the input and output ports 14, such that the user can read the real time speed on the interface.

In a preferred embodiment of the present invention, the handle 43 may equipped with a heartbeat sensor and a body fat meter, such that the physical condition of the user can be monitored via the embedded industrial controller of the present invention while the use is riding on the automatic bicycle 4′.

Accordingly, an embedded industrial controller with a bicycle frame shape according to the present invention has significantly improved functions than the conventional industrial controller, and further meets the conventional requirements such as dust proof, vibration proof, heat dissipation and pretty appearance. The embedded industrial controller with a bicycle frame shape of the present invention has great strength for being coupled with a rim, a tire, a seat pad, a handle, a pedal and a gear transmission device to form a bicycle or an automatic bicycle with logic control, sequence control and simulation control and thus to provide a user to have physical monitor, speed control and entertainments.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

What is claimed is:

1. An embedded industrial controller with a bicycle frame shape, comprising:
a casing with the bicycle frame shape including an upper tube, a lower tube, a front fork, a rear lower fork, a rear upper fork and a base tube;
a motherboard disposed in the upper tube;
a battery module mounted on the base tube;
an electrical power port disposed on the casing and electrically connecting the motherboard and the battery module; and
a plurality of input and output electrical ports disposed on the casing for receiving a first signal transmitted to the motherboard and outputting a second signal from the motherboard.

2. The embedded industrial controller of claim 1, wherein the motherboard comprises an input unit, a control unit, a memory unit, a calculation and logic unit, and an output unit.

3. The embedded industrial controller of claim 1, wherein the battery module is a lead acid battery, a lithium manganese dioxide battery, a lithium battery, a lithium iron battery, a nickel hydrogen battery, a fuel battery, or a combination thereof.

4. The embedded industrial controller of claim 1, wherein the electrical power port is an automotive connector, a cable connector, an air connector, a MIL-C-5015 circular military connector, a power connector, or a combination thereof.

5. The embedded industrial controller of claim 1, wherein the input and output electrical ports are RS-232/422/485 connectors, USB connectors, mini USB connectors, micro USB connectors, automotive connectors, D-type connectors, PCB connectors, European type connectors, RJ-45 connectors, HRS connectors, cable connectors, IEEE1394 connectors, HDMI connectors, mini HDMI connectors, Fujitsu connectors, Molex connectors, Weidmuller connectors, HONDA connectors, ERNI connectors, Tyco-Amp connectors, DVI connectors, FPC/FFC connectors, air connectors, SCSI connectors, MIL-C-5015 circular military connectors, mini-DIN connectors, C-type connectors, IDC connectors, DIN 41612 connectors, e-STAT connectors, STAT connectors, IDE connectors, PS/2 connectors, optical fiber S/PDIF output connectors, Modbus connectors, or a combination thereof.

6. The embedded industrial controller of claim 1, further comprising:
a hub motor disposed at an intersection of the rear upper fork and the rear lower fork; and
a motor driver disposed in the casing and electrically connected to the motherboard and the battery module, so as to transmit a control signal to the hub motor via the plurality of input and output electrical ports.

7. The embedded industrial controller of claim 6, wherein the hub motor is driven by 24 V, 36 V or 48 V.

8. The embedded industrial controller of claim 6, wherein the hub motor is controlled by the motor driver employing pulse width modulation.

9. The embedded industrial controller of claim 6, further comprising a sensor disposed on the hub motor and electrically connected to the motherboard for measuring a rotation speed of the hub motor and transmitting the rotation speed as a feedback signal to the motherboard.

10. The embedded industrial controller of claim 9, wherein the sensor is a Hall sensor, an encoder, a range finding switch, a magnetic reed switch, or a combination thereof.
